(19) United States
(12) Patent Application Publication
(10) Pub. No.: US 2012/0005151 A1
(43) Pub. Date: Jan. 5, 2012

(54) METHODS AND SYSTEMS OF CONTENT DEVELOPMENT FOR A DATA WAREHOUSE

(76) Inventors: Vineetha Vasudevan, Bangalore (IN); Jean-Michel Collomb, Grasse (FR); Arpit Agrawal, Madhya Pradesh (IN)

(21) Appl. No.: 13/016,433

(22) Filed: Jan. 28, 2011

(30) Foreign Application Priority Data
Jul. 1, 2010 (IN) 1863/CHE/2010

(51) Int. Cl. G06F 17/30

(52) U.S. Cl. 707/600; 707/E17.122

(57) ABSTRACT

In one embodiment, a processor-readable medium stores code representing instructions to cause a processor to perform a process including accessing a metadata specification and generating a data warehouse based on the metadata specification. The metadata specification includes metadata associated with generation of the data warehouse.

### RELATED APPLICATION

This application claims priority to Indian Patent Application No. 1863/CHE/2010 entitled “METHOD AND SYSTEM OF CONTENT DEVELOPMENT FOR A DATA WAREHOUSE” and filed on Jul. 1, 2010, which is incorporated by reference herein in its entirety.

### BACKGROUND

Data management includes collecting data, storing the collected data, and presenting the collected data in various forms, views, or according to various relationships or dimensions. Tools such as computers, electronic databases, and software applications such as data warehouses that leverage computers and electronic databases have simplified various aspects of data management. For example software vendors have developed proprietary database management applications for managing data within enterprises and other organizations. Alternatively, an organization can develop its own databases to meet its content management requirements.

Although such tools have simplified some aspects of data management, they have also created difficulties and challenges to data management. For example, ready availability of database management solutions and ease with which they can be deployed often result in multiple units within the same organization using different types of database applications for managing their content. This often results in a multiplicity of databases and software applications (or solutions) within the organization. Thus, the organization must support (i.e., provide technical support) for each of these databases and solutions. Additionally, an organization often stores and archives its data. Because data is stored multiple databases, storage and archive costs can increase.

Moreover, the organization's management may have analytical and reporting requirements vis-à-vis their organization's data for business decision making. Because the tools used for data management differ across units of the organization, some data sets can be incompatible with other data sets, which complicates pan-organization data analysis.

### BRIEF DESCRIPTION OF THE DRAWINGS

FIG. 1 is a graphic representation of a top level view of exemplary data warehouse architecture, according to an embodiment.

FIG. 2 is a flowchart of a process to generate a data warehouse, according to an embodiment.

FIG. 3 is an illustration of a computer-implemented method of content development for a data warehouse, according to an embodiment.

FIG. 4 is a flowchart of a process to generate a data mart including aggregate data, according to an embodiment.

FIG. 5 is a block diagram of a computing system, according to an embodiment.

FIG. 6 is a schematic block diagram of a system including a processor and storage media, according to an embodiment.

### DETAILED DESCRIPTION

Effective content management involves multiple activities. For example, effective content management involves organization of information architecture, content creation, business process understanding, software deployment, reporting and analysis. It also involves, for example, understanding content requirements, content life cycle, and understanding user needs. Data warehouses are commonly used to store and organize information for data management.

A data warehouse operates as a platform for collecting and aggregating content from diverse applications and data sources. That is, a data warehouse is an entity or tool where data is managed for analysis and reporting purposes. Said differently, a data warehouse is a repository of an organization's stored and historical data which enables the management to take business decisions.

A data mart is a logical and/or physical store of content (e.g., data) of a data warehouse. That is, a data mart typically defines an interface via which a user of a data warehouse can access a subset of the content of the data warehouse. Often, data marts are specific to a business entity or a service provided by an information system. For example, a data warehouse can include a data mart associated with an accounting department that stores or provides access to accounting information for an organization, a data mart associated with a production department that stores or provides access to production information for that organization, and an electronic mail data mart that stores or provides access to information related to an electronic mail system of that organization. Because the data marts include only a subset of the content in the data warehouse each data mart can present its content in a format that is specific to the department or entity with which that data mart is associated.

Typically, content development (e.g., defining or generating data marts) for a data warehouse involves a broad set of activities, the manual performance of which poses a number of challenges. As examples, the time involved in collecting or gathering content into the data warehouse is high, inconsistencies can occur in the warehouse, customizing the content is time consuming and difficult, the data collected or gathered into the data warehouse is stored differently at various databases resulting in data warehouses that are not portable across databases, and maintaining the data marts within the data warehouse are complex tasks. As a result of these challenges, such data warehouses are typically generated or compiled and configured manually (or statically) and are specific to a particular platform (e.g., databases and software applications). In other words, such data warehouses are not portable. Rather, such data warehouses are generated or compiled and configured for each platform to storing data that will be accessed via such data warehouses.

Embodiments discussed herein mitigate these challenges and automate content development. For example, embodiments discussed herein provide a method, a system, computer executable code, and/or a computer storage medium for automatic content development for a data warehouse using a content model. That is, data warehouses are specified or defined independent of the underlying platform (i.e., the platform at which the data to be included in the data warehouses are stored and accessed) and are generated or compiled and configured dynamically (or automatically) based on a content model. Thus, data warehouses described herein can support multiple platforms.

A content model defines the elements of and flow of data across or during a period of time during which that data is relevant such as, for example, across a product life cycle. The content model can contain lists of all elements of data (or data elements) and information about each data element. The data elements, flow of data, lists of data elements, and/or information about data elements, and/or other portions (or parts) of the content model can be referred to as content (i.e., the content of the content model). The content model also defines structure of content, organization of content, metadata, and/or other information related to the content model. That is, a content model can include information related to (e.g., documenting or describing) structure of and/or relationships among data within (or content of) a data warehouse.

Because content (e.g., data elements) can be developed, stored, collected, and/or moved in many different ways, by various people, and/or across multiple business units, content extraction and co-relation is a vital step in content life cycle management and analysis at a later date. As a specific example, a content model can be useful to automatically (i.e., without human interaction) generate a data warehouse including various domain-specific data marts (i.e., a store of operational and/or processed data) including data collected from diverse, multi-domain tools, and applications. Said differently, a content model that describes, for example, the structure of and relationships among data can be used by a content development environment to generate a data warehouse.

As used in this specification, the singular forms “a,” “an,” and “the” include plural referents unless the context clearly dictates otherwise. Thus, for example, the term “content model” is intended to mean one or more content models or a combination of content models. Additionally, as used herein, the term “module” refers to hardware such as circuitry and/or software, firmware, programming, machine- or processor-readable instructions, commands, or code that are stored at a memory and executed or interpreted at a processor. A module may include, by way of example, components, such as software components, processes, functions, attributes, procedures, drivers, firmware, data, databases, and data structures. The module may reside on a volatile or non-volatile storage medium and configured to interact with a processor of a computer system.

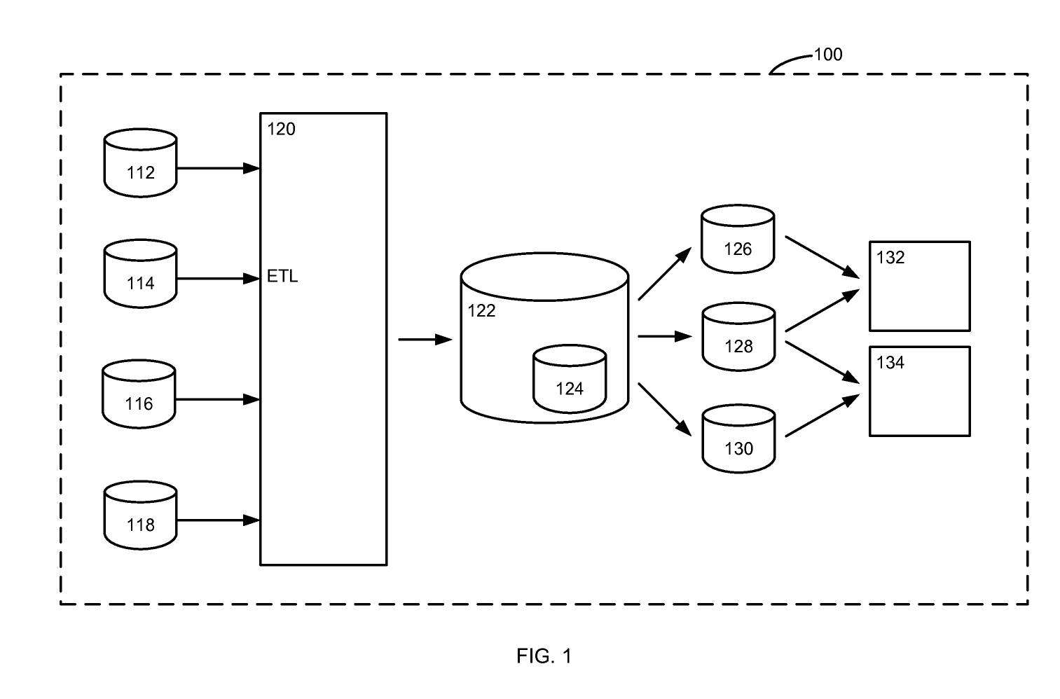

FIG. 1 shows a graphic representation of a top level view of exemplary data warehouse architecture 100 according to an embodiment. A data warehouse architecture includes the logical and physical structure of a data warehouse and is based on a number of factors. Some of these factors include: business processes within an enterprise, data structure, security, data modeling and organization, query requirements, metadata management, analytics and reporting requirements, and other considerations.

Referring to FIG. 1, the data warehouse architecture 100 includes data sources 112, 114, 116 and 118, data staging layer 120, data warehouse 122, metadata repository 124, data marts 126, 128 and 130, report generation module 126 and analysis module 128.

Data staging layer 120 includes a data staging process, which typically further includes various sub-processes. For example, data staging layer 120 includes Extract, Transform and Load sub-processes (illustrated as ETL in FIG. 1). These sub-processes can be collectively referred to as an ETL process. The Extract sub-process includes extraction of data from different sources and applications. In the present example, sub-process extracts data from data sources 112, 114, 116, and 118. The kind and complexity of data sources 112, 114, 116, and 118 vary depending on the nature of computer applications and processes involved. For example, computer systems, network elements, various computer databases, and/or other applications may act as data sources. The Transform sub-process involves transformation of data, such as, conversion, assembly (e.g., combination), and/or cleaning of data. The Load sub-process involves loading of data at a target location or an intermediate system for further processing. The ETL process results in collection, assembly, and reconciliation of data from multiple data sources.

The collected, assembled, and/or reconciled data is provided to the data warehouse 122 where it is summarized and archived for reporting purposes. The data flow process, for example, from data collection from data staging layer 120 to business view of the data (i.e., at data marts 126, 128, and 130), is specified (or defined or described) by metadata stored in the metadata repository 124. Metadata is data about other data. In other words, the metadata at metadata repository 124 describes each step of data processing as well as structure of data input and output. For example, metadata at metadata repository 124 ensures (or verifies) that the data has the right format and relevancy. Metadata repository 124 specifies a relational schema definition (e.g., a star schema, a snowflake schema, or another schema), staging and loading rules, aggregation rules, and/or business view layer.

Data warehouse architecture 100 can include data marts 126, 128 and 130, which are specialized repositories associated with a particular function, entity, or resource such as for a particular unit of a business. That is, data marts, as discussed above, focus on a specific business functions, entities, and/or resources within an organization. For example, there may be separate data marts for departments of an organization such as sales, finance, production, human resource, inventory, and/or information systems. Each data mart contains data pertaining to the specific business unit, entity, and/or resource with which the data mart is associated. Said differently, data marts 126, 128, and 130 are repositories of or interfaces to specialized subsets of content (or data) within data warehouse 122. The data in data warehouse 122 and/or data marts 126, 128 and 130 is used (i.e., is accessed) for generating reports and/or dashboards at report generation module 126 for a user and data analysis module 128.

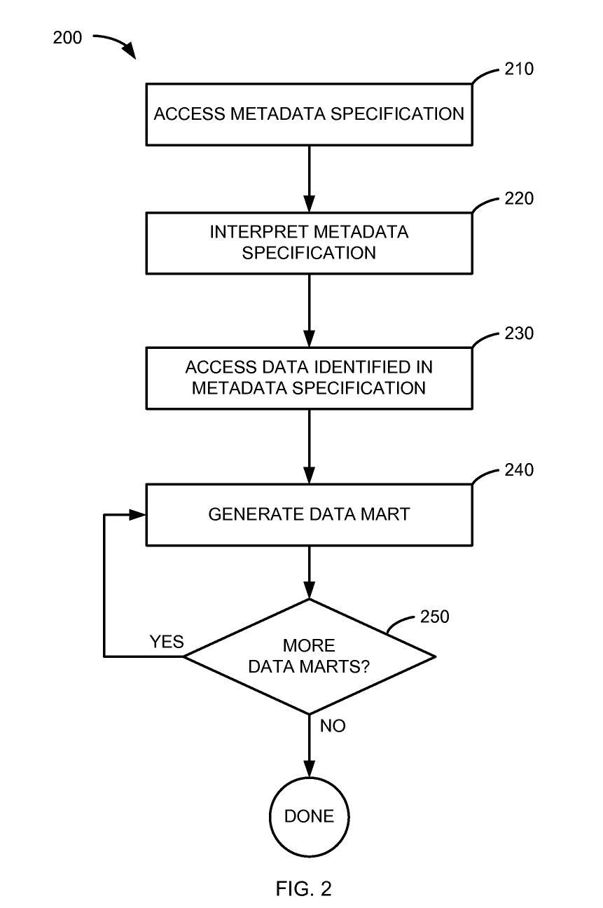

FIG. 2 is a flowchart of a process to generate a data warehouse, according to an embodiment. Process 200 can be implemented as a hardware module, as a software module hosted at a computing device, and/or as a combination of a hardware module and a software module. For example, process 200 can be implemented as application-specific circuitry or as a software module including instructions stored at a memory and executed at a processor in communication with the memory. More specifically, for example, process 200 can be implemented at a data warehouse content development module. A data warehouse content development module is a module at which a data warehouse is generated (or compiled and configured) based on a content model such as, for example, a content model described within a metadata specification.

A metadata specification is accessed at block 210, for example, at a data warehouse content development module. In other words, a collection of metadata that describes a data mart of a data warehouse is accessed by a data warehouse content development module of that data warehouse. The data warehouse content development module interprets the metadata specification at block 220 to determine the structure and/or content (or data) sources for the data mart. For example, the metadata specification can be an XML document and the XML document can be parsed by the data warehouse content development module to generate a Document Object Model (“DOM”) representation of the metadata specification. Said differently, a data warehouse content development module can interpret a metadata specification to generate artifacts (i.e., information related to the structure and content of a data mart) from the metadata specification.

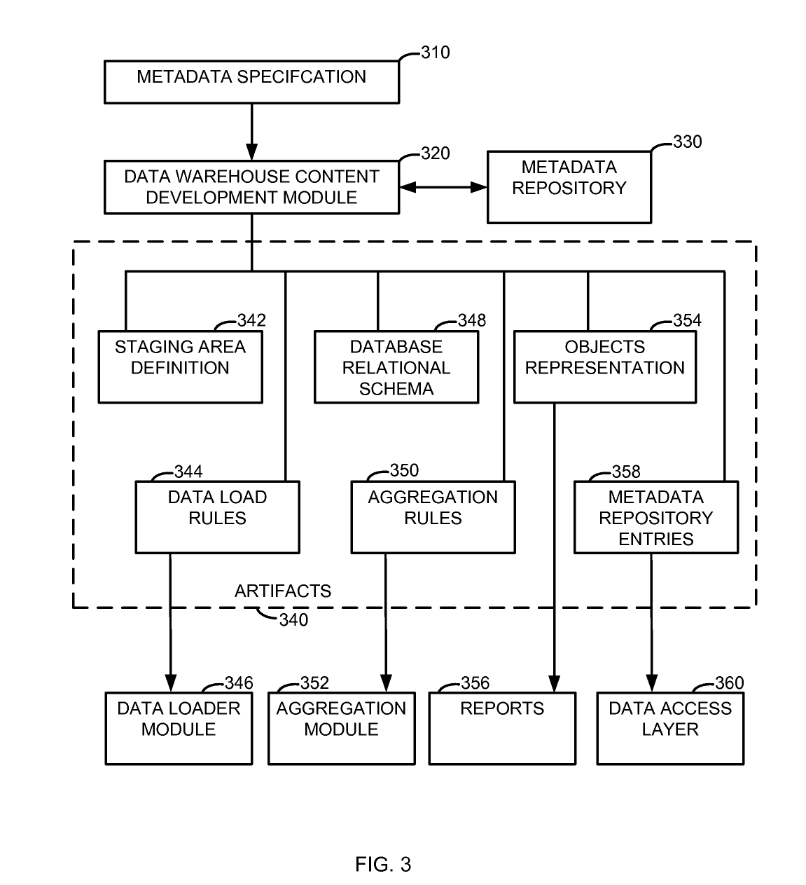

After the metadata specification is interpreted, data identified in the metadata specification are accessed at 230 for inclusion in the data mart. For example, artifacts from the metadata specification can identify content of the data warehouse that should be aggregated within a data mart. The data mart is then generated at block 240. In other words, the structure of the data mart is instantiated at the data warehouse. More specifically, data schema models can be generated, data cubes (discussed in more detail below in relation to FIG. 3) can be generated, aggregate data can be prepared, and/or other structures or components of a data mart can be generated.

If the metadata specification accessed at block 210 includes additional information such as data schemas, aggregation metadata, and/or other information related to data marts at block 250, process 200 can return to block 240 at which additional data marts are generated. Thus, process 200 can loop at blocks 240 and 250 to generate the data marts of a data warehouse. If there is no more information related to additional data marts at block 250, process 200 can terminate.

Process 200 can include addition or fewer blocks than those illustrated in FIG. 2. Additionally, one or more blocks of process 200 can be rearranged. Furthermore, although process 200 is discussed above with reference to an example environment including a data warehouse content development module, process 200 is applicable within other environments.

FIG. 3 is an illustration of a computer-implemented method of content development in a data warehouse according to an embodiment. Metadata specification 310 is provided to module automation module 320. Metadata specification 310 conforms to a metadata specification format is defines (or describes) a data mart within a data warehouse. In some embodiments, metadata specification 310 is provided from a source external to data warehouse content development module such as, for example, a remote computer server and is accessed by the data warehouse content development module. That is, metadata specification 310 can be received from a remote device via, for example, a communications link such as a communications network.

As discussed above, metadata can be described as data about other data. Metadata specification 310 provides (or defines or describes) a structure or hierarchy of defined elements that describe the contents (i.e., data) of a data mart, the structure of the data mart, and/or requirements related to how the elements and/or contents of the data mart are to be used and represented.

Prior to providing metadata specification 310 for a data mart of a data warehouse to data warehouse content development module 320, the method can include a step of creating a the input content in a metadata specification format defining, for example, the content and/or structure for a data mart. For example, a software application hosted at a computer system can include a graphical user interface (“GUI”) via which a user of the software application can define the content and structure of the data mart.

In one embodiment, metadata specification 310 is a user-defined specification based on Extensible Markup Language (“XML”). That is, the input content in the metadata specification format can be an XML document that defines metadata for defining content and/or structure for a data mart (also referred to herein as a content pack) and provides a description of data warehouse structure. That is, metadata specification 310 can describe the content and/or structure of a data mart and the structure of the data warehouse. The content definition can be provided, for example, by an application developer keen on creating a data mart using a data warehouse content development module (described later).

Metadata specification 310 can define the structure of a data mart by describing fields and relationships between fields for content in the data mart that are written to a relational database as dimension tables and fact tables. Metadata specification 310 can include various parts (or sections) such as a logical section, a relational metadata, aggregate metadata, and/or a data load section. Examples of these metadata specification parts are discussed below.

A logical section describes the business view of the content (i.e., data) within a data mart of a data warehouse. The complexity of doing business, especially for large corporations, has increased the need for more efficient analysis of data. Two typical types of such analysis are data mining and On-Line Analytic Processing (“OLAP”). Data mining can be achieved by organizing the data within data marts and running simple queries and/or reports in or via the data marts of the data warehouse system.

In some embodiments, it can be desirable to obtain more detailed and/or flexible analysis of data. OLAP can provide more flexible analysis of data. Data stores such as data warehouses and data marts that support OLAP organize data in a multidimensional data model. That is, a response to an OLAP query (e.g., a response for a data mart to an OLAP query) can be a multidimensional array in which the individual values in the multidimensional array are the facts or measures (i.e., the content or the data) and each index dimension of the multidimensional array are the dimensions of the multidimensional data model. As a specific example, a response to an OLAP query can be a matrix (or pivot format) in which the rows and columns are dimensions and the values are the facts or measures.

Data stores that support OLAP typically define OLAP cubes to organize or represent then content of the data store. An OLAP cube is a logical and/or physical structure within a data store that organizes data. For example, an OLAP cube can be based on a star schema in a relational database in which the fact table includes the facts or measures and the dimensions are derived from dimension tables of the star schema. In other embodiments, an OLAP cube can be based on a snowflake schema in a relational database in which the fact table includes the facts or measures and the dimensions are derived from dimension tables of the snowflake schema. In other words, an OLAP cube is a data structure that allows fast analysis of data by representing data from various databases and making them compatible. For example, an OLAP cube allows user to perform analytical operations on the content of the OLAP cube relative to one or more dimensions such as slice, dice, drill down, drill up, roll-up, and/or pivot.

Moreover, in some embodiments OLAP cubes can also include custom dimensional hierarchies or granularities that are used for data roll-up. That is, a dimension can be divided into granularities and an OLAP cube rolled-up relative to the granularities of the dimension. As a specific example, an OLAP cube can include a date dimension with a hierarchy including granularities (or levels) such as minute, hour, day, week, month, calendar quarter, fiscal quarter, calendar year, and/or fiscal year. As another example, an information system can have granularities such as communications network segment, server, virtual machine, and application instance.

The logical section includes instructions, specifications, descriptions, and/or directives that define the OLAP cubes (generically referred to herein as data cubes). That is, the logical section describes (or specifies or defines) the data cubes that are accessible at the data mart. In other words, the data cubes described (or specified or defined) within the logical section are the business view of the data mart with which the logical section is associated. For example, the logical section can identify a fact table and dimension tables defined in the relation metadata discussed above. Said differently, the logical section can describe data cubes by specifying the measures (i.e., contents) of the data cube and the dimensions of the data cube relative to a relational metadata. Thus, the data cubes are described relative to a relational data rather than the underlying data store or stores (e.g., database) from which the measures were collected. In other words, the data cubes and, thus, the contents of the data cubes are described independent of the data stores from which those contents were collected.

Relational metadata is a section of a metadata specification that describes the structure of the relational schema (i.e., dimensions and facts or measures) that will be defined in a data store such as a data warehouse or a data mart. In a relational data store, a schema may define tables, fields, views, packages, indexes, relationships, synonyms, and other elements. There are a number of ways of arranging schema objects in the schema models. One schema model is a star schema. The data in the warehouse are stored in a set of tables organized in a star schema. The central table of the star schema is called the fact table, and the related tables represent dimensions and can be referred to as dimension tables. Dimensions provide the structure (or framework) for disaggregating reports (or other response to queries such as multidimensional arrays from a data mart that supports OLAP) into smaller parts. In other words, dimensions are the bases along which analytical operations such as slice, dice, drill down, drill up, roll-up, and/or pivot can be applied to content of a data mart or other data store.

Thus, the relational metadata or a metadata specification describes (or specifies or defines) the schema model or a data store such as a data warehouse or data mart. That is, the relational metadata describes the fact table, dimension table or tables, and/or relationships between the fact table and dimension table or tables. As specific example, the relational metadata describes conformed dimensions, type I slowly changing dimensions (“SCDs”), a star schema, and/or a snowflake schema.

Aggregate metadata is a section of a metadata specification that specifies the aggregation rules that involve measures to be aggregated, aggregation functions to be applied, and/or a set of dimensional attributes relative to which the aggregation will be performed. For example, the facts (or measures) to be aggregated and the dimensions along and/or dimension hierarchy levels at which the facts are to be aggregated. More specifically, for example, aggregation metadata can specify that facts that is collected each hour and is related to a number of incidents should be aggregated as an average along a time dimension at dimension hierarchy levels of day and week. Alternatively, those facts can be aggregated as an average along a time dimension and an organization dimension to produce per-organization aggregates.

An aggregate (or aggregate data) is the result of one or more operations (i.e., aggregation functions) on measures in a data store. For example, the contents (e.g., measures) of a data cube can be aggregated by averaging those measures along a dimension of the data cube. That is, the aggregation function can be an averaging function. Other aggregation functions include a maximum (or ceiling) a minimum (or floor), a summation, standard deviation, median, or other function. In some embodiments, an aggregation function can be user defined. That is, the operations that realize the aggregation function can be specified in the metadata specification by a user.

The aggregate metadata specify the aggregation functions that may be applied on raw measures in the data warehouse or data mart. That is, the aggregate metadata section of the metadata specification specifies measures to be aggregated, a dimension relative to which the measures should be aggregated, and an aggregation function that will be applied to the measures. In some embodiments, the aggregate metadata also specifies a granularity (e.g., a level of a hierarchy) at which the metadata should be aggregated.

The aggregate metadata identify the measures that will be aggregated and the dimensions relative to which the measures will be aggregated relative to one or more data cubes described in the logical section. Thus, although the measures that are aggregated can be values taken from operational data of various data stores (i.e., different databases), the aggregates can be uniformly described relative to the data cubes. Thus, the aggregate metadata specifies aggregates independent of the data stores at which the operational data are stored.

In some embodiments, the measures that are aggregated based on the aggregate metadata are the results of an aggregation function. In other words, aggregate content (or aggregate data) can be identified by the metadata specification as measures that are aggregated to define additional aggregate content. For example, the aggregation metadata can define an aggregation by identifying measures of a data cube that will be aggregated (or the source data), one or more dimensions such as a date dimension along which the measures will be aggregated, a granularity such as hourly at which the measures will be aggregated, and an aggregation function such as average. Thus, this aggregation is an hourly average aggregation. Accordingly, the aggregate data generated in response to this aggregation is a group of measures that represent the average of the source data at hourly intervals. The aggregate metadata can also define a daily average aggregation similar to the hourly average aggregation, but at a granularity of daily and specifying the hourly average aggregation as the source data. Thus, the daily average aggregation generates a group of measures or aggregate data that represent the average of the hourly average aggregation at daily intervals based on the aggregate data of the hourly average aggregation. Said differently, the output of one aggregation can be the input to another.

In some embodiments, an aggregation can specify multiple dimensions relative to which an aggregation data is generated. That is, the aggregate metadata can specify multiple dimensions and content (i.e., measures) of a data cube will be applied to the aggregation function relative to both dimensions.

A data-load section describes a mapping to the schema or schemas described in the relational metadata from a data staging layer. Prior to any data transformations that may occur within a data warehouse or data mart, the raw data must become accessible for the data warehouse and data mart. Data from various sources (e.g., databases) that are Extracted and Transformed are Loaded to the data warehouse from the penultimate step of staging in the ETL. The data-load section describes the mapping between data in the staging area to the representation (e.g., logical representation) of that data and/or, for example, aggregates of that data at the data warehouse. The metadata included in the data-load section is also used to derive the structure of the staging area and create appropriate staging tables at deployment time, and to generate data load rules which will be used by the data loader module 346 at run time to load data into the data warehouse.

The metadata specification described above provides details or information to define or generate a specific data mart for a particular type of content. For example, the specification allows creation of a specific data mart for sales, for sales related content. Similarly, specific data marts may be created for inventory, production, human resource, depending on content. In other words, the metadata specification describes the structure and logical (or business) view of data marts using metadata that a data warehouse content development module can interpret to generate the described data marts. Because the various sections of the metadata specification describe the data marts (or components such as OLAP cubes of the data marts) relative to other sections of the metadata specification, the data mart can be described independent of the underlying data stores from which the content (i.e., data) of the data marts are collected. Thus, the metadata specification can be portable across various underlying data stores.

Referring to FIG. 3, data warehouse content development module 320 receives metadata specification 310 and generates a data mart (not shown in FIG. 3) and related artifacts (i.e., information related to the structure and content of a data mart) 340 for a data warehouse and/or data mart.

Data warehouse content development module 320 is a module that drives the generation of data marts and related artifacts for a data warehouse and/or one or more data marts. In an embodiment, data warehouse content development module 320 is a Java™ language based tool that is used to automate the creation of data marts and artifacts (relational database schema, business view, pre-aggregations, data load rules and threshold rules). Data warehouse content development module 320 reads the input metadata specification and stores all detail present therein in a metadata repository 330. As discussed above, a metadata repository specifies the relational schema definition, the staging and loading rules, the aggregation rules and the business view layer.

These artifacts generated at data warehouse content development module 320 can include the following staging area definition, database relational schema 348, objects representation 354, data load rules 344, aggregation rules 350, and/or metadata repository entries 358. Staging area definition 342 is a place (or structure or construct) where data is processed before entering the data warehouse and/or data marts. The data is cleaned and processed before entering into the data warehouse. A staging area simplifies building summaries and general warehouse management. Data warehouse content development module 342 drives the creation of a staging schema based on metadata specification 310 in, for example the data-load section of the metadata specification 310.

After the data has been cleansed and transformed into a structure consistent with the data warehouse requirements or specifications, data is ready for loading into the data warehouse. Data from the staging area is loaded to the data warehouse tables based on data load rules 344 derived from metadata specification 310. The data load process is driven by load control instructions or directives included, for example, in a data-load section of metadata specification 310 that specifies all the information required to perform the data load process. The load control instructions are processed by a data loader module 346 of the data warehouse, which loads the data into the data warehouse.

Relational schema 348 is derived from relational metadata from metadata specification 310. That is, data warehouse content development module 342 drives the creation of a relational schema specific to the data mart based on the relational metadata section of input metadata specification 310. As discussed above, this specification of the relational metadata is independent of underlying database technology.

Aggregation rules 350 are generated based on aggregate metadata of metadata specification 310 discussed above. Input metadata specification 310 can specify a set of aggregations (also referred to as pre-aggregations) for measures defined in an OLAP cube against the key dimensions including, for example, a time dimension. As discussed above, OLAP is a tool designed to facilitate explorative kind of analysis of massive amounts of data warehouse data via, for example, data marts. Data warehouse content development module 320 creates a set of pre-aggregation rules which are passed on to the aggregation module 352 to perform the necessary aggregations on the data in the data warehouse (i.e., the content of the data marts).

Objects representation 354 is a representation of the business (or logical) view of the data (i.e., the view of the contents of a data warehouse or data mart that is exposed to the end-user). In other words, objects representation 354 is an interface layer between a data store and a user using the objects for query. Said differently, objects representation 354 hides the typical data schema model structure from the user. For example, objects representation 354 can be a Business Objects Universe™. Data warehouse content development module 320 generates objects representation 354 based on the logical model entries specified in input metadata specification 354. For example, objects representation 354 can include data cubes defined in a logical section of metadata specification 310. Objects representation 354 may be directly used by a report/analytics solution developer in creating reports 356 based on the data schema model. Objects representation 354 can also be extended by a user, thereby giving a user the provision for further customization. That is, a user can provide scripts, libraries, instructions, and/or other commands to objects representation 354 to extend or supplement the functionalities of objects representation 354.

Metadata repository entries 358 for Data Access Layer 360 presents the business view represented in the logical section is presented to end users via Data Access Layer 360 Application Programming Interface (“APIs”). For example, data warehouse content development module 320 can include a set of Java ^{TM} APIs for retrieving data from metadata repository 330. These APIs are realized by data access layer 360. In other words, requests for data from metadata repository 330 and/or content from the data warehouse and/or a data mart thereof are processed by data access layer 360 APIs implemented, for example, in Java to fetch the business view of data warehouse or data mart content (i.e., data) from the data warehouse.

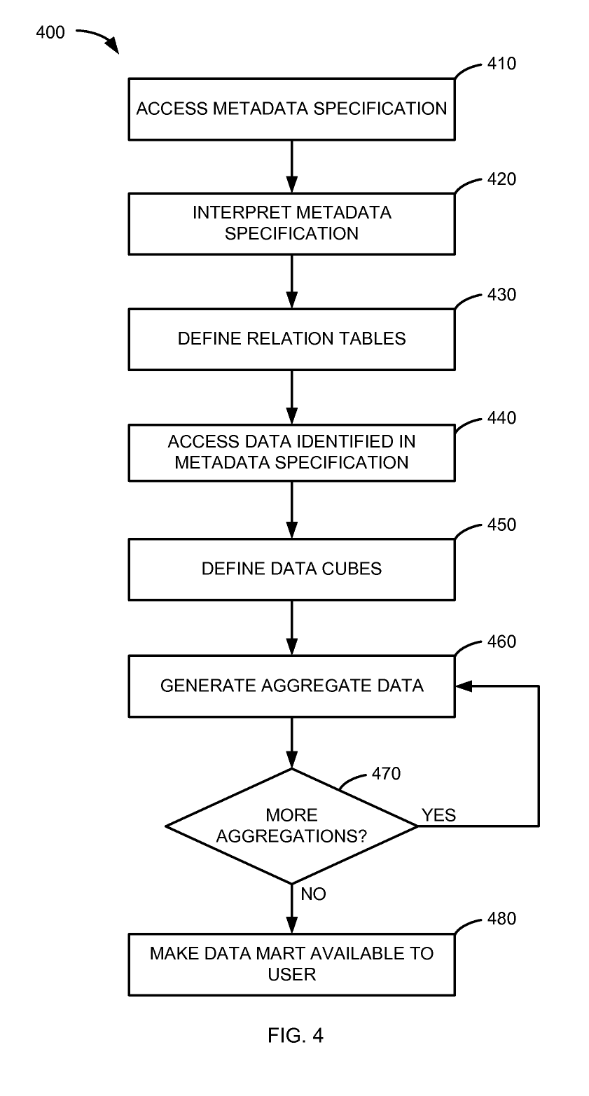

FIG. 4 is a flowchart of a process to generate a data mart including aggregate data, according to an embodiment. Process 400 can be implemented as a hardware module, as a software module hosted at a computing device, and/or as a combination of a hardware module and a software module. For example, process 400 can be implemented as application-specific circuitry or as a software module including instructions stored at a memory and executed at a processor in communication with the memory. More specifically, for example, process 400 can be implemented at a data warehouse content development module.

A metadata specification is accessed at block 410, for example, at a data warehouse content development module. In other words, a collection of metadata that describes a data mart of a data warehouse is accessed by a data warehouse content development module of that data warehouse. For example, the metadata specification can be received at a data warehouse system via a communications network from computer system such as a computer server. Alternatively, for example, the metadata specification can be received from a hard disk drive and accessed by the data warehouse system. The data warehouse content development module interprets the metadata specification at block 420 to determine the structure and/or content (or data) sources for the data mart. For example, the metadata specification can be an XML document and the XML document can be parsed by the data warehouse content development module to generate a Document Object Model (“DOM”) representation of the metadata specification. Said differently, a data warehouse content development module can interpret a metadata specification to generate artifacts (i.e., information related to the structure and content of a data mart) from the metadata specification.

After the metadata specification is interpreted, the relation tables that store measures (or the content) of the data mart are defined based on the metadata specification at block 430. That is, the fact table and dimension tables of the model schema described in, for example, relational metadata of the metadata specification are defined. Data identified in the metadata specification as content of the data mart are accessed at 440 and stored at the relation tables defined at block 430. For example, artifacts from the metadata specification can identify content of the data warehouse that should be accessed at a data staging layer and stored at the relation tables of a data mart.

Data cubes of the data mart are defined at block 450 based on the metadata specification accessed at block 410. For example, data structures within a software module hosted at a computing device can be instantiated and/or initialized based on a description of a data cube included within a logical section of the metadata specification. For example, references to a fact table and dimension tables defined at block 440 can be initialized within a data warehouse content development module at block 450.

Aggregation data is generated at block 460 based on the metadata specification. In other words, an aggregation described within aggregate metadata of the metadata specification. More specifically, for example, an aggregation function can be applied to content of the data warehouse identified within the metadata specification. That is, measures included within a data cube can be aggregated with respect to (or along) one or more dimensions of the data cube to generate the aggregate data.

As discussed above, a metadata specification can describe multiple aggregations. If there are more aggregations described within the metadata specification at block 470, process 400 can return to block 460 can generate aggregate data based on that aggregation. Thus, blocks 460 and 470 can be repeated for each aggregation for the metadata specification interpreted at block 420. Moreover, as discussed above, the aggregations can each identify different data sources (i.e., different content within the data warehouse that is aggregated or rolled-up at block 460), aggregation functions or operations, and/or dimensions with respect to which data from the data sources is aggregated. Furthermore, aggregate data generated during one iteration of blocks 460 and 470 can be the data source of another aggregation or iteration of blocks 460 and 470. That is, an aggregation described within the metadata specification can specify the aggregate data generated in response to another aggregation as the source data for that aggregation.

The data mart is then made available to a user at block 480. That is, the logical and/or physical structures of the data mart defined and/or generated at the content of the data warehouse at those structures (e.g., accessible via those structures) is exposed to the user via, for example, one or more APIs. Thus, the user can query the data mart and access the data mart content via, for example, the data cubes and aggregate data of the data mart.

Process 400 can include addition or fewer blocks than those illustrated in FIG. 4. For example, process 400 can include a block to store aggregate data of each aggregation such that the aggregate data is accessible via the business (or logical) view of the data mart. Additionally, one or more blocks of process 400 can be rearranged. Furthermore, although process 400 is discussed above with reference to an example environment including a data warehouse content development module, process 400 is applicable within other environments.

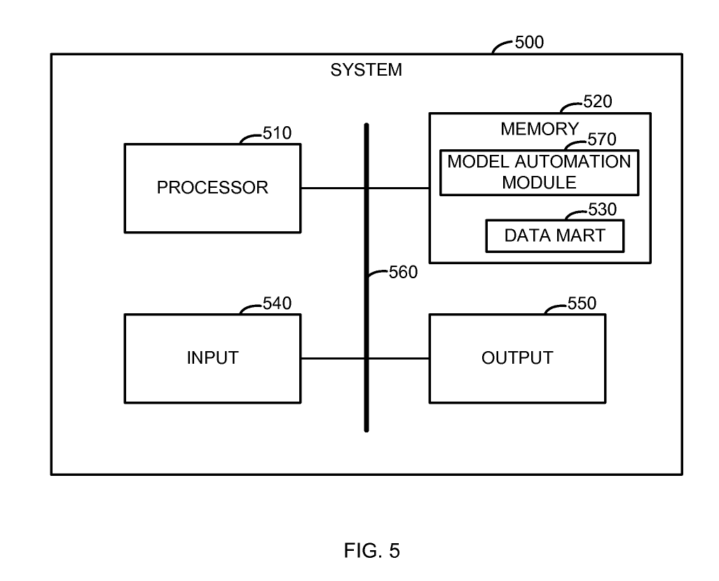

FIG. 5 is a block diagram of a computing system, according to an embodiment. System 500 can be any kind of computing device, such as, but not limited to, a personal computer, a desktop computer, a laptop computer, a notebook computer, a network computer, a personal digital assistant (PDA), a mobile device, a hand-held device, or any other suitable computing. Further, system 500 may be a standalone system or a network system (such as, but not limited to, a client/server architecture) connected to other computing devices through wired or wireless means.

System 500 includes processor 510, for executing software instructions, memory 520, for storing data mart 530 and data warehouse content development module 570, input module 540, and output module 550. These components may be coupled together via system bus 560.

Processor 510 is arranged to generate data mart 530 data mart based on a metadata specification received via the input module 540, and to store data mart 530 in memory 520. For example, processor 510 can execute instructions, codes, or commands stored at data warehouse content development module 570 to interpret a metadata specification and generate data mart 530 based on the metadata specification. In one embodiment, the metadata specification is an XML-based specification such as an XML document including XML elements representing the sections or a metadata specification discussed above in relation to FIG. 3.

Memory 520 may include computer system memory such as, but not limited to, SDRAM (Synchronous DRAM), DDR (Double Data Rate SDRAM), Rambus™ DRAM (RDRAM), Rambus™ RAM, etc. or storage memory media, such as, a floppy disk, a hard disk, a CD-ROM, a DVD, a pen drive, etc. As discussed above, memory 520 stores data mart 530.

Input module (or device) 540 may include a mouse, a key pad, a touch pad or screen, a voice recognizer, and the like, for accessing a metadata specification to system 500 for generating one or more data marts such as data mart 530. That is, a user, for example, of system 500 can provide a metadata specification to system 500 via input module 540. Alternatively, for example, input module 540 can be an interface to a data store such as a hard drive, a database, and/or a data storage service at which a metadata specification is stored and can be accessed by input module 540. As yet another example, input module 540 can be a data store such as a hard drive, a database, and/or a data storage service at which a metadata specification is stored and system 500 can access the metadata specification at input module 540. Output module or (device) 550 can include various output devices such as a Virtual Display Unit (VDU), a printer, a scanner, and the like, for displaying generated data mart 530. In some embodiments, input module 540 and/or output module 550 can each include a software module or software stack such as a device driver in communication.

It should be appreciated that the system components depicted in FIG. 5 are for the purpose of illustration only and the actual components may vary depending on the computing system and architecture deployed for implementation of the present solution. The various components described above may be hosted on a single computing system or multiple computer systems, including servers, connected together through suitable means.

The embodiments described provide an effective mechanism to maintain consistency in data model across end-to-end description of a data warehouse structure, from the staging area up to the business view in a technology independent manner, and generate a technology specific implementation of the data warehouse. The modularity in content development allows core models that can be reused by other data marts such as application content packs. The embodiments also allow portability. That is, because the data marts (or the components of data marts such as data cubes) or a data warehouse are described within a metadata specification with reference to other sections of the metadata specification independent of the data stores from which the content of the data warehouse was collected, a single content model specified within the metadata specification can be used across different data store (e.g., relational database) technologies.

It will be appreciated that the embodiments within the scope of the present solution may be implemented in the form of a computer program product including computer-executable instructions, such as program code, which may be run on any suitable computing environment in conjunction with a suitable operating system, such as, Microsoft Windows, Linux or UNIX operating system.

Some embodiments include a processor and a related processor-readable medium having instructions or computer code thereon for performing various processor-implemented operations. Such a processor can be a general-purpose processor or an application-specific process and can be implemented as a hardware module and/or a software module. A hardware module can be, for example, a microprocessor, a microcontroller, an application-specific integrated circuit (“ASIC”), a programmable logic device (“PLD”) such as a field programmable gate array (“FPGA”), and/or other electronic circuits that perform operations. A software module can be, for example, instructions, commands, and/or codes stored at a memory and executed at another processor. Such a software module can be defined using one or more programming languages such as Java™, C++, C, an assembly language, a hardware description language, and/or another suitable programming language. For example, a processor can be a virtual machine hosted at a computer server including a microprocessor and a memory.

In some embodiments, a processor can include multiple processors. For example, a processor can be a microprocessor including multiple processing engines (e.g., computation, algorithmic or thread cores). As another example, a processor can be a computing device including multiple processors with a shared clock, memory bus, input/output bus, and/or other shared resources. Furthermore, a processor can be a distributed processor. For example, a processor can include multiple computing devices, each including a processor, in communication one with another via a communications link such as a computer network.

Examples of processor-readable media include, but are not limited to: magnetic storage media such as a hard disk, a floppy disk, and/or magnetic tape; optical storage media such as a compact disc (“CD”), a digital video disc (“DVDs”), a compact disc read-only memory (“CD-ROM”), and/or a holographic device; magneto-optical storage media; non-volatile memory such as read-only memory (“ROM”), programmable read-only memory (“PROM”), erasable programmable read-only memory (“EPROM”), electronically erasable read-only memory (“EEPROM”), and/or FLASH memory; and random-access memory (“RAM”). Examples of computer code include, but are not limited to, micro-code or micro-instructions, machine instructions, such as produced by a compiler, and files containing higher-level instructions that are executed by a computer using an interpreter. For example, an embodiment may be implemented using Java™, C++, or other object-oriented programming language and development tools. Additional examples of computer code include, but are not limited to, control signals, encrypted code, and compressed code.

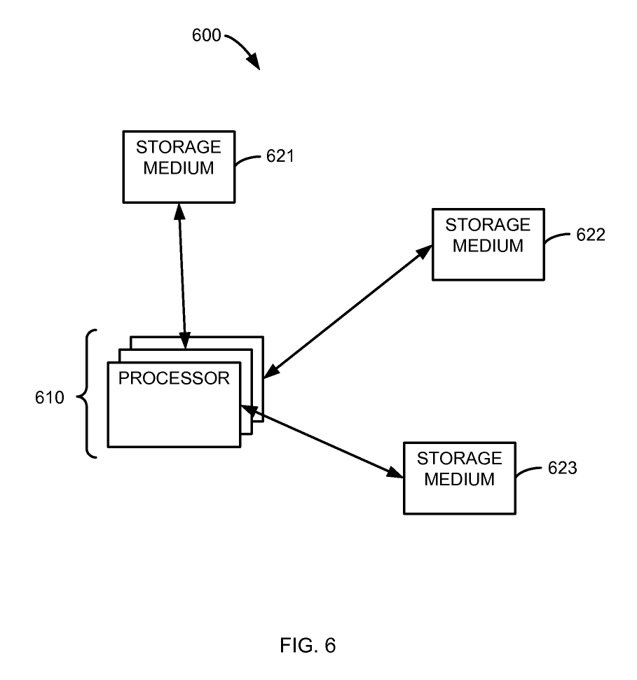

As an example of a system including one or more processors and processor-readable storage media, FIG. 6 is a schematic block diagram of system 600 including a processor and storage media, according to an embodiment. As illustrated in FIG. 6, system 600 includes one or more processors 610 operatively coupled to storage medium 621, storage medium 622, and storage medium 623. One or more processors 610 can access instructions or code at storage medium 621, storage medium 622, and storage medium 623. Storage media 621, 622, and 623 can be any processor-readable media and/or related devices to access processor-readable media. For example, storage medium 621 can be a hard disk drive including a magnetic storage medium, storage medium 622 can be an optical drive such as a DVD drive and can accept DVD storage media on which processor-readable instructions can be stored, and storage medium 623 can be a FLASH memory drive with a Universal Serial Bus (“USB”) interface. In some embodiments, storage media 621, 622, and/or 623 can be local to (e.g., coupled to a common computing device) one or more processors 610. In some embodiments, storage media 621, 622, and/or 623 can be remote from (e.g., coupled to a separate computing device) one or more processors 610 and in communication with one or more processors 610 via communications link. Furthermore, one or more of storage media 621, 622, and/or 623 can be local to one or more processors 610 and one or more of the remaining of storage media 621, 622, and/or 623 can be remote from one or more processors 610.

As a more specific example, one or more processors 610 can be included within a computing device such as a communications device having an internal hard disk drive data store represented by storage medium 621 and a removable solid-state data store such as a Secure Digital High-Capacity (“SDHC”) memory card represented by storage medium 622. The computing device can also include a USB host controller to communicate with a USB FLASH memory drive represented by storage medium 623. One or more processors 610 can access processor-readable instructions such as processor-readable instructions that implement a data warehouse content development module at any of storage media 621, 622, and/or 623. Said differently, one or more processors 610 can interpret or execute instructions at processor-readable media via storage medium 621, storage medium 622, and/or storage medium 623.

Alternatively, for example, storage media 621 and 622 can be remote from a computing device including one or more processors 610 and storage medium 623 can be local to that computing device. The computing device including one or more processors 610 can download a report generation tool application from one or both of remote storage media 621 or 622 via communications link such as a communications network to local storage medium 623 and execute the report generation tool application from local storage medium 623.

In some embodiments, system 600 can include one or more memories such as RAM that function as a cache between one or more of storage medium 621, storage medium 622, and/or storage medium 623 and one or more processors 610 for instructions or code stored (or accessible) at one or more of storage medium 621, storage medium 622, and/or storage medium 623.

While certain embodiments have been shown and described above, various changes in form and details may be made. For example, some features that have been described in relation to one embodiment and/or process can be related to other embodiments. In other words, processes, features, components, and/or properties described in relation to one embodiment can be useful in other embodiments. Furthermore, it should be understood that the systems and methods described herein can include various combinations and/or sub-combinations of the components and/or features of the different embodiments described. As a specific example, embodiments discussed in relation to a communications network can be applicable to other information systems. Thus, features described with reference to one or more embodiments can be combined with other embodiments described herein.

What is claimed is:

1. A processor-readable medium storing code representing instructions to cause a processor to perform a process, the process comprising:
accessing a metadata specification including metadata associated with generation of a data warehouse; and
generating the data warehouse based on the metadata specification.

2. A processor-readable medium according to claim 1, wherein the metadata specification is an XML document.

3. A processor-readable medium according to claim 1, wherein the metadata specification includes a description of a plurality of data mart structures.

4. A processor-readable medium according to claim 1, the process further comprising:
generating the metadata specification including metadata associated with generation of the data warehouse.

5. A processor-readable medium according to claim 1, wherein the metadata specification includes at least one of the following parts: a logical section, relational metadata, aggregate metadata, and a data load section.

6. A processor-readable medium according to claim 1, the process further comprising:
generating a plurality of data marts based on the metadata specification.

7. A processor-readable medium according to claim 1, wherein:
the data warehouse is generated at a data warehouse content development module based on the metadata specification; and
the data warehouse content development module generates related artifacts of the data warehouse.

8. A processor-readable medium according to claim 1, wherein:
the data warehouse is generated at a data warehouse content development module based on the metadata specification;
the data warehouse content development module generates related artifacts for the data warehouse; and
the related artifacts includes at least one of the following: a staging area definition, data load rules, a relational schema, aggregation rules, a objects representation, and metadata repository entries.

9. A processor-readable medium according to claim 1, wherein the generated data warehouse is a first data warehouse associated with a first platform, the process further comprising:
generating a second data warehouse based on the metadata specification, the second data warehouse associated with a second platform different from the first platform.

10. A method according to claim 1, further comprising:
determining an aggregation function, a data source, and a plurality of dimensions for aggregate data based on the metadata specification, the data source and the plurality of dimensions specified within the metadata specification; and
defining the aggregate data relative to the plurality of dimensions based on the aggregation function and the data source, the data warehouse including the aggregate data.

11. A method according to claim 1, further comprising:
determining a first aggregation function, a first data source, and a plurality of dimensions for first aggregate data based on the metadata specification, the first data source and the plurality of dimensions specified within the metadata specification;
determining a second aggregation function and a second data source for second aggregate data based on the metadata specification, the second data source specified within the metadata specification;
defining the first aggregate data relative to the plurality of dimensions based on the first aggregation function and the first data source, the data warehouse including the first aggregate data; and
defining the second aggregate data relative to the plurality of dimensions based on the second aggregation function and the second data source, the first aggregate data being the second data source, the data warehouse including the second aggregate data.

12. A system, comprising:
an input module to access a metadata specification for generating a data warehouse;
a processor to interpret the metadata specification and to generate the data warehouse based on the metadata specification; and
a memory to store the data warehouse.

13. A system according to claim 12, wherein the metadata specification format is an XML specification format.

14. A system according to claim 12, further comprising:
a data warehouse content development module at the memory to generate the data warehouse based on the metadata specification.

15. A system according to claim 12, wherein the metadata specification format includes at least one of the following parts: a logical section, relational metadata, aggregate metadata, and a data load section.

16. A system according to claim 12, further comprising:
a data warehouse content development module at the memory to:
determine an aggregation function, a data source, and a dimension for aggregate data based on the metadata specification, the data source and the dimension specified within the metadata specification, and
define the aggregate data relative to the dimension based on the aggregation function and the data source, the data warehouse including the aggregate data.

17. A system according to claim 12, further comprising:
a data warehouse content development module at the memory to:
determine an aggregation function, a first data source, a first granularity, and a plurality of dimensions for first aggregate data based on the metadata specification, the first data source and the plurality of dimensions specified within the metadata specification;
determine a second data source and a second granularity for second aggregate data based on the metadata specification, the second data source specified within the metadata specification, the first aggregate data being the second data source;
define the first aggregate data relative to the plurality of dimensions and the first granularity based on the aggregation function and the first data source, the data warehouse including the first aggregate data; and
define the second aggregate data relative to the plurality of dimensions and the second granularity based on the aggregation function and the second data source, the data warehouse including the second aggregate data.

18. A processor-readable medium storing code representing instructions to cause a processor to perform a process, the process comprising:
receiving a metadata specification for generating a data warehouse;
determining an aggregation function, a data source, and a plurality of dimensions for aggregate data based on the metadata specification, the data source and the plurality of dimensions specified within the metadata specification;
defining the aggregate data relative to the plurality of dimensions based on the aggregation function and the data source; and
generating the data warehouse based on the metadata specification, the data warehouse including the aggregate data.

19. The processor-readable medium of claim 18, wherein the aggregate data is first aggregate data aggregated at a first granularity relative to the plurality of dimensions and the data source is a first data source, the process further comprising:
determining a second data source for second aggregate data based on the metadata specification, the first aggregate data being the second data source; and
defining the second aggregate data relative to a second granularity of the plurality of dimensions.

20. The processor-readable medium of claim 18, wherein: wherein the plurality of dimensions is a first plurality of dimensions, the aggregate data is first aggregate data aggregated at a first granularity relative to the first plurality of dimensions, the aggregation function is a first aggregation function, and the data source is a first data source, the process further comprising:
determining a second aggregation function, a second data source, and a second plurality of dimensions for second aggregate data based on the metadata specification, the second data source and the second plurality of dimensions specified within the metadata specification; and
defining the second aggregate data relative to the second plurality of dimensions based on the second aggregation function and the second data source.
